(19) United States
(12) Patent Application Publication
(10) Pub. No.: US 2026/0124751 A1
(43) Pub. Date: May 7, 2026

(54) OBSTACLE AVOIDANCE MOTION CARRIER

(71) Applicant: PRIMAX ELECTRONICS LTD., Taipei City (TW)

(72) Inventors: YUNG-TAI PAN, Taipei City (TW); CHANG-MING HUANG, Taipei City (TW)

(21) Appl. No.: 18/986,760

(22) Filed: Dec. 19, 2024

(30) Foreign Application Priority Data
Nov. 7, 2024 (TW) 113142819

(51) Int. Cl. B25J 9/16; B25J 5/00; B25J 9/00; B25J 9/12

(52) U.S. Cl. CPC B25J 9/1666; B25J 5/007; B25J 9/0009; B25J 9/126

(57) ABSTRACT

An obstacle avoidance motion carrier includes a motion base and a rotation module. The motion base is configured to autonomously move, turn and rotate. The rotation module is disposed on the motion base and includes a rotation axis actuator and a rotation carrier plate. The rotation axis actuator is fixed on the motion base. The rotation carrier plate is disposed on the rotation axis actuator and connected to the rotation axis actuator, in which the rotation axis actuator is configured to rotate to drive the rotation carrier plate to rotate relative to the motion base. The obstacle avoidance motion carrier may further include a first horizontal movement module and/or a second horizontal movement module to achieve obstacle avoidance performance of the obstacle avoidance motion carrier in horizontal direction(s).

### FIELD OF THE INVENTION

The present invention relates to an obstacle avoidance motion carrier.

### BACKGROUND OF THE INVENTION

Generally, an autonomous mobile robot (AMR) is an integrated fixed structure. Therefore, the autonomous mobile robot can only rotate in a channel whose width is greater than its own rotation diameter, and cannot rotate in a channel whose width is smaller than its own rotation diameter.

### SUMMARY OF THE INVENTION

The present invention provides an obstacle avoidance motion carrier, which includes a motion base and a rotation module. The motion base is configured to autonomously move, turn and rotate. The rotation module is disposed on the motion base and includes a rotation axis actuator and a rotation carrier plate. The rotation axis actuator is fixed on the motion base. The rotation carrier plate is disposed on the rotation axis actuator and connected to the rotation axis actuator, in which the rotation axis actuator is configured to rotate to drive the rotation carrier plate to rotate relative to the motion base.

In some embodiments of the present invention, the obstacle avoidance motion carrier further includes a first horizontal movement module disposed on the rotation carrier plate and including a first horizontal axis actuator and a first carrier plate. The first horizontal axis actuator is fixed on the rotation carrier plate and has a first moving slide block. The first carrier plate is disposed on the first horizontal axis actuator and fixed on the first moving slide block, in which the first horizontal axis actuator is configured to move the first moving slide block so that the first carrier plate moves relative to the rotation carrier plate along a first horizontal axis.

In some embodiments of the present invention, when the rotation axis actuator rotates to drive the rotation carrier plate to rotate relative to the motion base, the rotation carrier plate and the first horizontal movement module are rotated together.

In some embodiments of the present invention, the obstacle avoidance motion carrier further includes a second horizontal movement module disposed on the first carrier plate and including a second horizontal axis actuator and a second carrier plate. The second horizontal axis actuator is fixed on the first carrier plate and has a second moving slide block. The second carrier plate is disposed on the second horizontal axis actuator and fixed on the second moving slide block, in which the second horizontal axis actuator is configured to move the second moving slide block so that the second carrier plate moves relative to the first carrier plate along a second horizontal axis different from the first horizontal axis.

In some embodiments of the present invention, when the rotation axis actuator rotates to drive the rotation carrier plate to rotate relative to the motion base, the rotation carrier plate, the first horizontal movement module and the second horizontal movement module are rotated together.

In some embodiments of the present invention, the first horizontal axis actuator moves the first moving slide block so that the first carrier plate moves relative to the rotation carrier plate along the first horizontal axis, the first carrier plate and the second horizontal movement module are moved together along the first horizontal axis.

In some embodiments of the present invention, the motion base includes two driving wheels capable of bidirectional rotation.

In some embodiments of the present invention, the motion base includes a navigation element and/or an obstacle avoidance sensing element only provided on one side of the motion base.

### BRIEF DESCRIPTION OF THE DRAWINGS

Aspects of the present invention are best understood from the following embodiments, read in conjunction with accompanying drawings. However, it should be understood that in accordance with common practice in the industry, various features have not necessarily been drawn to scale. Indeed, shapes of the various features may be suitably adjusted for clarity, and dimensions of the various features may be arbitrarily increased or decreased.

FIG. 1 is a schematic perspective view of an obstacle avoidance motion carrier according to an embodiment of the present invention.

FIG. 2 is a schematic perspective view of the obstacle avoidance motion carrier of FIG. 1 (a cover body of a motion base and a rotation carrier plate are transparently displayed).

FIG. 3 is a schematic perspective view of an obstacle avoidance motion carrier according to an embodiment of the present invention.

FIG. 4 is a schematic perspective view of the obstacle avoidance motion carrier of FIG. 3 (a first carrier plate is transparently displayed).

FIG. 5 is a schematic perspective view of an obstacle avoidance motion carrier according to an embodiment of the present invention.

FIG. 6 is a perspective schematic view of the obstacle avoidance motion carrier of FIG. 5 (a second carrier plate is transparently displayed).

FIG. 7 is a schematic perspective view of an obstacle avoidance motion carrier and a load-carrying base according to an embodiment of the present invention.

### DETAILED DESCRIPTION OF THE PREFERRED EMBODIMENT

The advantages and features of the present invention and the method for achieving the same will be described in more detail with reference to exemplary embodiments and accompanying drawings to make it easier to understand. However, the present invention can be implemented in different forms and should not be construed as being limited to the embodiments set forth herein. On the contrary, for those skilled in the art, the provided embodiments will make this disclosure more thorough, comprehensive and complete to convey the scope of the present invention.

The spatially relative terms in the text, such as “beneath” and “over”, are used to facilitate the description of the relative relationship between one element or feature and another element or feature in the drawings. The true meaning of the spatially relative terms includes other orientations. For example, when the drawing is flipped up and down by 180°, the relationship between the one element and the other element may change from “beneath” to “over.” The spatially relative descriptions used herein should be interpreted the same.

As mentioned in the prior art, generally, the autonomous mobile robot is an integrated fixed structure. Therefore, the autonomous mobile robot can only rotate in a channel whose width is greater than its own rotation diameter, and cannot rotate in a channel whose width is smaller than its own rotation diameter. Accordingly, the present invention provides an obstacle avoidance motion carrier, which includes a motion base and a rotation module. The rotation module includes a rotation axis actuator and a rotation carrier plate. A load-carrying base may be provided above the rotation carrier plate. The rotation axis actuator is configured to rotate to drive the rotation carrier plate to rotate relative to the motion base, and the motion base is configured to move, turn and rotate autonomously. When the autonomous mobile robot enters a channel with a width smaller than its own rotation diameter, the motion base itself rotates in one direction (e.g., clockwise rotation) and the rotation axis actuator rotates in an opposite direction (e.g., counterclockwise rotation) to drive the rotation carrier plate and the load-carrying base thereon rotate in the opposite direction relative to the motion base. This allows the rotation carrier plate and the load-carrying base thereon to maintain a same absolute orientation, which is not changed with the orientation of the motion base. That is, in terms of appearance, only the motion base turns, but the rotation carrier plate and the load-carrying base thereon may not turn, so that the obstacle avoidance motion carrier can turn and then leave the channel with the width smaller than its own rotation diameter to effectively solve the problem described above. In addition, the obstacle avoidance motion carrier may further include a first horizontal movement module and/or a second horizontal movement module, so that a first carrier plate of the first horizontal movement module can move along a first horizontal axis and/or a second carrier plate of the second horizontal movement module can move along a second horizontal axis to achieve obstacle avoidance performance of the obstacle avoidance motion carrier in horizontal direction(s). Various embodiments of the obstacle avoidance motion carrier of the present invention will be described in detail below.

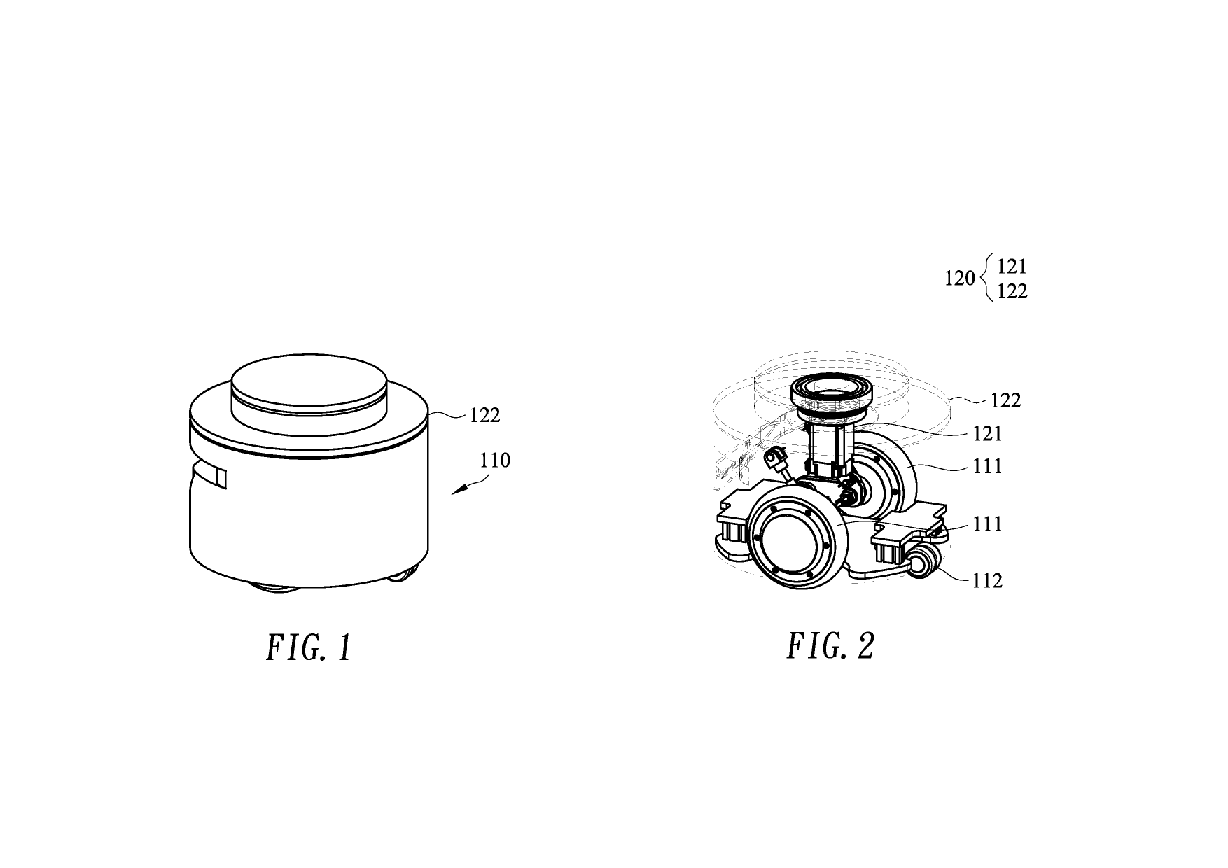

FIG. 1 is a schematic perspective view of an obstacle avoidance motion carrier according to an embodiment of the present invention. FIG. 2 is a schematic perspective view of the obstacle avoidance motion carrier of FIG. 1 (a cover body of a motion base and a rotation carrier plate are transparently displayed). As shown in FIGS. 1 and 2, the obstacle avoidance motion carrier includes a motion base 110 and a rotation module 120.

The motion base 110 is configured to move autonomously. In some embodiments, as shown in FIG. 2, the motion base 110 includes two driving wheels 111 capable of bidirectional rotation. By the two driving wheels 111 rotating in the same direction, the motion base 110 can move. The motion base 110 is also configured to turn and rotate autonomously. By the two driving wheels 111 rotating in opposite directions, respectively, the motion base 110 can turn or rotate. In some embodiments, the motion base 110 further includes an unpowered driven wheel 112.

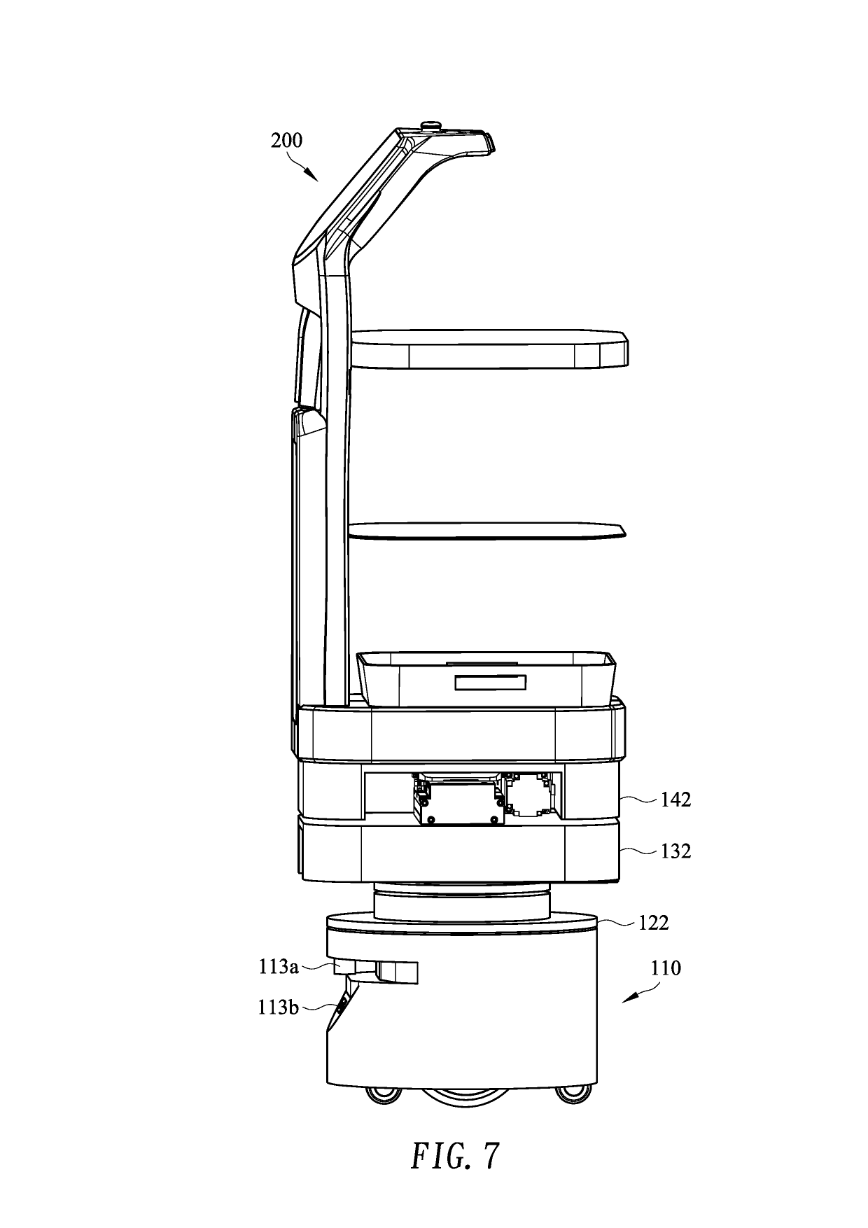

In some embodiments, referring to FIG. 7, the motion base 110 includes a navigation element 113a and/or an obstacle avoidance sensing element 113b. Since the motion base 110 can rotate, the navigation element 113a or the obstacle avoidance sensing element 113b can be disposed only on one side of the motion base 110. There is no need to dispose the navigation element 113a and/or the obstacle avoidance sensing element 113b on different sides of the motion base 110.

The rotation module 120 is disposed on the motion base 110 and includes a rotation axis actuator 121 and a rotation carrier plate 122. The rotation axis actuator 121 is fixed on the motion base 110. In some embodiments, a cover body of the motion base 110 includes an upper cover, and the upper cover has an opening, and the rotation axis actuator 121 is disposed in the opening. The rotation carrier plate 122 is disposed on the rotation axis actuator 121 and connected to the rotation axis actuator 121. The rotation axis actuator 121 is configured to rotate to drive the rotation carrier plate 122 to rotate relative to the motion base 110. As such, when the autonomous mobile robot (which may include, for example, the obstacle avoidance motion carrier shown in FIG. 1 and a load-carrying base (e.g., a load-carrying base 200 shown in FIG. 7 )) enters a channel whose width is smaller than its own rotation diameter, the motion base 110 itself rotates in one direction (e.g., clockwise rotation) and the rotation axis actuator 121 rotates in an opposite direction (e.g., counterclockwise rotation) to drive the rotation carrier plate 122 and the load-carrying base thereon to maintain a same absolute orientation, which is not changed with the orientation of the motion base 110. That is, in terms of appearance, only the motion base 110 turns, and the rotation carrier plate 122 and the load-carrying base thereon may not turn, so that the obstacle avoidance motion carrier can turn and then leave the channel with the width smaller than its own rotation diameter.

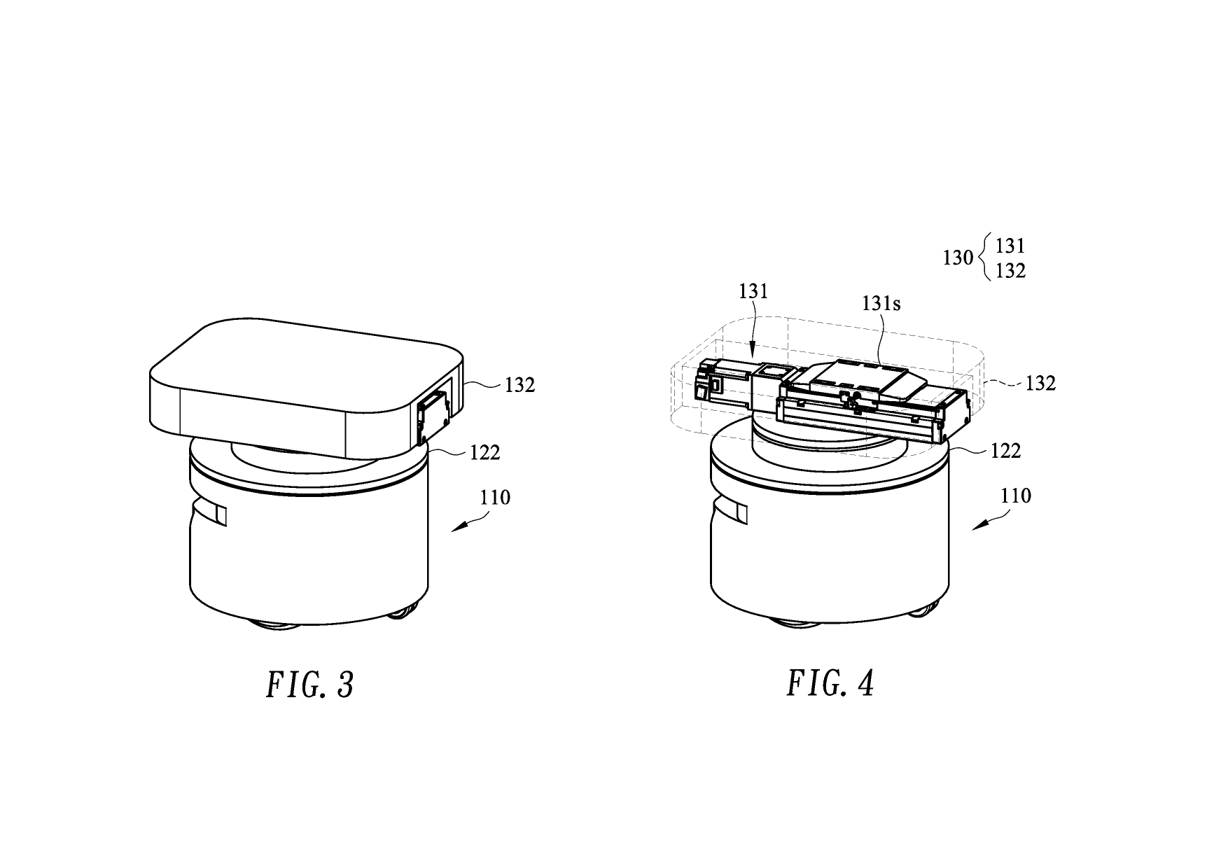

FIG. 3 is a schematic perspective view of an obstacle avoidance motion carrier according to an embodiment of the present invention. FIG. 4 is a schematic perspective view of the obstacle avoidance motion carrier of FIG. 3 (a first carrier plate is transparently displayed). As shown in FIGS. 3 and 4, the obstacle avoidance motion carrier further includes a first horizontal movement module 130, which is disposed on the rotation carrier plate 122 and includes a first horizontal axis actuator 131 and a first carrier plate 132. The first horizontal axis actuator 131 is fixed on the rotation carrier plate 122 and has a first moving slide block 131s. The first carrier plate 132 is disposed on the first horizontal axis actuator 131 and fixed on the first moving slide block 131s. The first horizontal axis actuator 131 is configured to move the first moving slide block 131s so that the first carrier plate 132 can move bidirectionally relative to the rotation carrier plate 122 along a first horizontal axis. For example, the first carrier plate 132 can move bidirectionally along a length direction of the first carrier plate 132. As such, when there is an obstacle near a load-carrying base of an autonomous mobile robot (e.g., it may include the obstacle avoidance motion carrier shown in FIG. 3 and a load-carrying base (e.g., the load-carrying base 200 shown in FIG. 7)), the first carrier plate 132 and the load-carrying base thereon can be moved horizontally along the first horizontal axis to avoid the obstacle.

In another aspect, in some embodiments, as shown in FIGS. 2 to 4, when the rotation axis actuator 121 rotates to drive the rotation carrier plate 122 to rotate relative to the motion base 110, the rotation carrier plate 122 and the first horizontal movement modules 130 are rotated together.

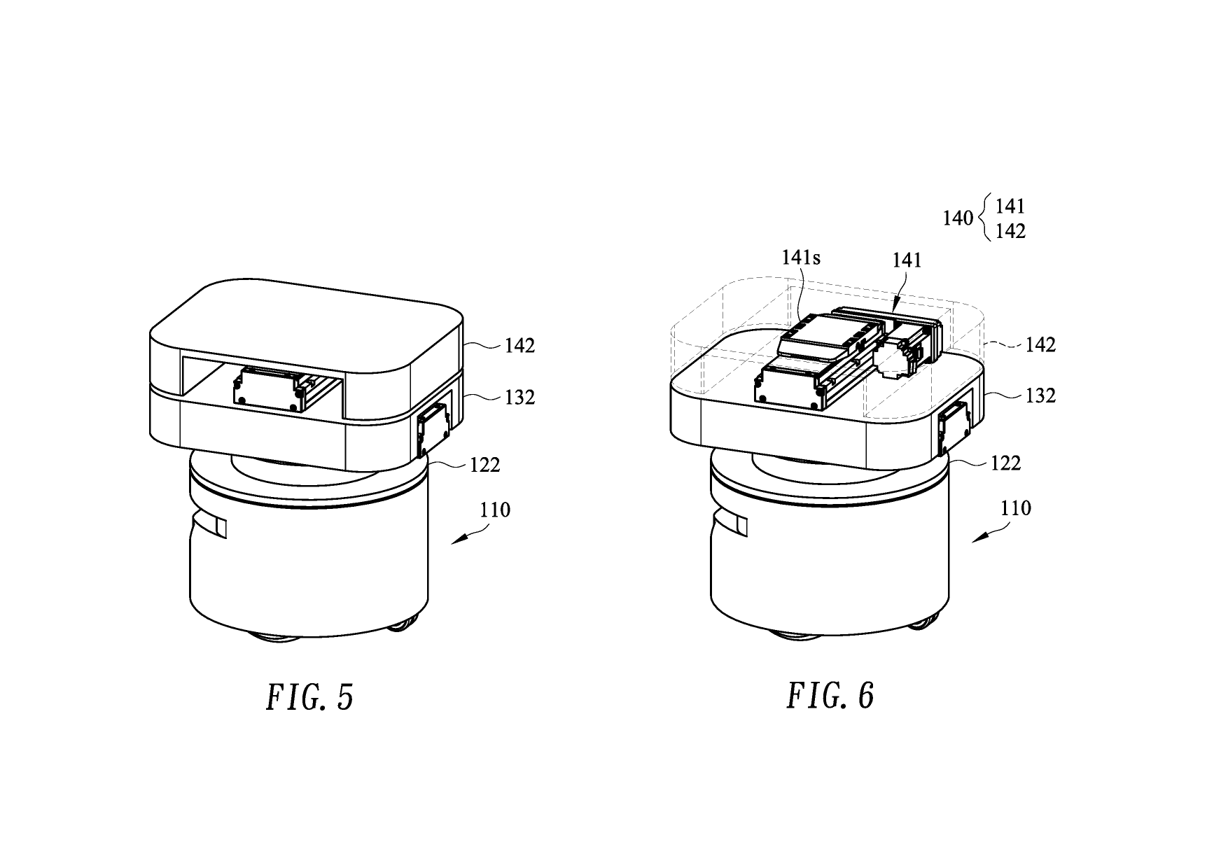

FIG. 5 is a schematic perspective view of an obstacle avoidance motion carrier according to an embodiment of the present invention. FIG. 6 is a perspective schematic view of the obstacle avoidance motion carrier of FIG. 5 (a second carrier plate is transparently displayed). As shown in FIGS. 5 and 6, the obstacle avoidance motion carrier further includes a second horizontal movement module 140, which is disposed on the first carrier plate 132 and includes a second horizontal axis actuator 141 and a second carrier plate 142. The second horizontal axis actuator 141 is fixed on the first carrier plate 132 and has a second moving slide block 141s. The second carrier plate 142 is disposed on the second horizontal axis actuator 141 and fixed on the second moving slide block 141s. The second horizontal axis actuator 141 is configured to move the second moving slide block 141s so that the second carrier plate 142 moves relative to the first carrier plate 132 along a second horizontal axis that is different from the first horizontal axis. For example, the second carrier plate 142 can move bidirectionally along a width direction of the second carrier plate 142. As such, when there is an obstacle near a load-carrying base of an autonomous mobile robot (e.g., it may include the obstacle avoidance motion carrier shown in FIG. 5 and a load-carrying base (e.g., the load-carrying base 200 shown in FIG. 7)), the second carrier plate 142 and the load-carrying base thereon can be moved horizontally along the second horizontal axis to avoid the obstacle.

In another aspect, in some embodiments, as shown in FIGS. 2 to 6, when the rotation axis actuator 121 rotates to drive the rotation carrier plate 122 to rotate relative to the motion base 110, the rotation carrier plate 122, the first horizontal movement module 130 and the second horizontal movement module 140 can be rotated together.

In some embodiments, as shown in FIGS. 4 to 6, the first horizontal axis actuator 131 moves the first moving slide block 131s so that the first carrier plate 132 moves relative to the rotation carrier plate 122 along the first horizontal axis, the first carrier plate 132 and the second horizontal movement module 140 can be moved together along the first horizontal axis to avoid the obstacle. For example, the first carrier plate 132 and the second horizontal movement module 140 can be moved bidirectionally along the length direction of the first carrier plate 132.

In some embodiments, a width of the first carrier plate 132 is smaller than a width of the rotation carrier plate 122. In some embodiments, a length of the first carrier plate 132 is greater than a width of the rotation carrier plate 122 so that an area of the first carrier plate 132 for carrying objects is increased. In some embodiments, a width of the second carrier plate 142 is less than the width of the rotation carrier plate 122. In some embodiments, a length of the second carrier plate 142 is greater than the width of the rotation carrier plate 122 so that an area of the second carrier plate 142 for carrying objects is increased. In some embodiments, the width of the second carrier plate 142 is substantially the same as the width of the first carrier plate 132, and the length of the second carrier plate 142 is substantially the same as the length of the first carrier plate 132. However, the present invention is not limited to the above embodiments. The width of the rotation carrier plate 122, the length and width of the first carrier plate 132, and the length and width of the second carrier plate 142 can be appropriately adjusted according to actual needs.

In addition, in other embodiments, referring to FIGS. 5 to 6, positions of the first horizontal movement module 130 and the second horizontal movement module 140 can be interchangeable. In other embodiments, referring to FIGS. 3 to 4, the rotation module 120 may be provided with only the second horizontal movement module 140 shown in FIGS. 5 to 6.

FIG. 7 is a schematic perspective view of an obstacle avoidance motion carrier and a load-carrying base according to an embodiment of the present invention. As shown in FIG. 7, the load-carrying base 200 can be disposed and fixed on the second carrier plate 142. However, the present invention is not limited thereto. In other embodiments, the load-carrying base 200 may be disposed and fixed on the rotation carrier plate 122 as shown in FIG. 1 or the first carrier plate 132 as shown in FIG. 3. Please refer to FIGS. 1 to 7. The motion base 110 of the obstacle avoidance motion carrier can provide movement, turn and rotation functions. The rotation module 120, the first horizontal movement module 130 and the second horizontal movement module 140 of the obstacle avoidance motion carrier can provide relative rotation and two types of horizontal obstacle avoidance functions of the load-carrying base 200, respectively. As such, the obstacle avoidance performance of the autonomous mobile robot in various directions can be achieved.

However, the above are only the preferred embodiments of the present invention, and should not be used to limit the scope of implementation of the present invention, that is, simple equivalent changes and modifications made in accordance with claims and description of the present invention are still within the scope of the present invention. In addition, any embodiment of the present invention or claim does not need to achieve all the objectives or advantages disclosed in the present invention. In addition, the abstract and the title are not intended to limit the scope of claims of the present invention.

What is claimed is:

1. An obstacle avoidance motion carrier, comprising:
a motion base, configured to autonomously move, turn and rotate; and
a rotation module, disposed on the motion base and comprising:
a rotation axis actuator, fixed on the motion base; and
a rotation carrier plate, disposed on the rotation axis actuator and connected to the rotation axis actuator, wherein the rotation axis actuator is configured to rotate to drive the rotation carrier plate to rotate relative to the motion base.

2. The obstacle avoidance motion carrier of claim 1, further comprising:
a first horizontal movement module, disposed on the rotation carrier plate and comprising:
a first horizontal axis actuator, fixed on the rotation carrier plate and having a first moving slide block; and
a first carrier plate, disposed on the first horizontal axis actuator and fixed on the first moving slide block, wherein the first horizontal axis actuator is configured to move the first moving slide block so that the first carrier plate moves relative to the rotation carrier plate along a first horizontal axis.

3. The obstacle avoidance motion carrier of claim 2, wherein when the rotation axis actuator rotates to drive the rotation carrier plate to rotate relative to the motion base, the rotation carrier plate and the first horizontal movement module are rotated together.

4. The obstacle avoidance motion carrier of claim 2, further comprising:
a second horizontal movement module, disposed on the first carrier plate and comprising:
a second horizontal axis actuator, fixed on the first carrier plate and having a second moving slide block; and
a second carrier plate, disposed on the second horizontal axis actuator and fixed on the second moving slide block, wherein the second horizontal axis actuator is configured to move the second moving slide block so that the second carrier plate moves relative to the first carrier plate along a second horizontal axis different from the first horizontal axis.

5. The obstacle avoidance motion carrier of claim 4, wherein when the rotation axis actuator rotates to drive the rotation carrier plate to rotate relative to the motion base, the rotation carrier plate, the first horizontal movement module and the second horizontal movement module are rotated together.

6. The obstacle avoidance motion carrier of claim 4, wherein the first horizontal axis actuator moves the first moving slide block so that the first carrier plate moves relative to the rotation carrier plate along the first horizontal axis, the first carrier plate and the second horizontal movement module are moved together along the first horizontal axis.

7. The obstacle avoidance motion carrier of claim 1, wherein the motion base comprises two driving wheels capable of bidirectional rotation.

8. The obstacle avoidance motion carrier of claim 1, wherein the motion base comprises a navigation element and/or an obstacle avoidance sensing element only provided on one side of the motion base.
